(19) United States
(12) Patent Application Publication
(10) Pub. No.: US 2011/0184624 A1
(43) Pub. Date: Jul. 28, 2011

(54) GAS DETECTION DEVICE

(75) Inventors: Meng Han, Aachen (DE); Albrecht Kraus, Kerkrade (NL)

(73) Assignee: KONINKLIJKE PHILIPS ELECTRONICS N.V., EINDHOVEN (NL)

(21) Appl. No.: 13/002,530

(22) PCT Filed: Jul. 7, 2009
(86) PCT No.: PCT/IB09/52944

§ 371 Date: Mar. 24, 2011

(30) Foreign Application Priority Data
Jul. 10, 2008 (EP) 08104708.6
Jul. 23, 2008 (EP) 08104839.9

(51) Int. Cl. G06G 7/70; G01N 21/39

(52) U.S. Cl. 701/101; 356/437

(57) ABSTRACT

The present invention relates to a gas detection device (200) comprising a laser sensor unit (100). The laser sensor unit (100) is adapted to emit laser light being adapted to be at least partially absorbed by a gas to be detected (50). The laser sensor unit (100) is further adapted to generate measurement data based on self-mixing-interference (SMI) in an active cavity (10) of the laser sensor unit (100). The measurement data is influenced by the absorption of laser light by the gas to be detected, and an analyzer circuit (120) is provided to determine the presence and/or concentration of the gas to be detected (50), based on the measurement data received from the laser sensor unit (100).

### FIELD OF THE INVENTION

The present invention is related to a gas detection device comprising a laser sensor unit, a control system comprising such a gas detection device and a vehicle comprising such a control system.

The current invention is further related to a corresponding method of detecting the presence and/or concentration of gas.

### BACKGROUND OF THE INVENTION

The application of a vertical cavity surface emitting laser (VCSEL) for laser gas absorption spectroscopy is known from patent WO2005026705. The device described in WO2005026705 comprises at least two VCSEL diodes and two external photodetectors. The VCSEL injection currents are modulated at frequency F and 2F, respectively. The concentration of the absorbing gas is detected by two lock-in amplifiers.

The device is complex and expensive.

### SUMMARY OF THE INVENTION

It is an object of the present invention to provide an improved gas detection device.

The object is achieved by means of a gas detection device comprising at least one laser sensor unit, a driving circuit and an analyzer circuit,
the laser sensor unit comprising at least one active cavity, electrodes, at least one optical feedback structure, a detection volume and at least one detector, the active cavity comprising an active layer sandwiched between a first reflective structure and a second reflective structure, the first reflective structure having a higher reflectivity than the second reflective structure, the electrodes being adapted to inject electrical current in the active layer, the detector being coupled to the active cavity, the detection volume being arranged between the second reflective structure and the optical feedback structure and the detection volume being adapted to contain a gas to be detected,
the driving circuit being electrically coupled to the electrodes and the driving circuit being adapted to electrically pump the active cavity such that first light is emitted via the second reflective structure in the detection volume and at least a part of the first light being adapted to be absorbed by an absorption band of the gas to be detected,
the optical feedback structure being arranged to scatter or reflect the first light through the detection volume, causing it to re-enter the active cavity,
the scattered or reflected first light re-entering the active cavity being second light causing a variation of a laser power in the active cavity in dependence on the absorption of the first light by the gas to be detected in the detection volume,
the detector being adapted to generate measurement data being related to the laser power in the active cavity,
the detector being coupled to the analyzer circuit and the analyzer circuit being adapted to determine the presence and/or the concentration of the gas to be detected, based on the measurement data received from the detector.

The detection chamber may have two openings, one where the gas flows in and one where the gas flows out. A gas flow may pass the detection chamber and the gas detection device may determine whether a gas to be detected (e.g. CO) is present in the gas flow and/or determine the concentration of the gas to be detected. The measurement of the presence and/or the concentration of the gas to be detected may be done by tuning the wavelength of the first light to one absorption band of the gas to be detected. The optical absorption, by the gas to be detected, of the first light on its way to the optical feedback structure and on its way back after being scattered or reflected by the optical feedback structure influences the intensity of the second light re-entering the active cavity and consequently causes variations of the laser power or more in general of the optical power density in the active cavity. These variations of the optical power density can be detected by the detector being coupled to the active cavity. The detection of the variations of the optical power density in the active cavity enables a simple and low cost gas detection device in comparison to the prior art. The detector may be either coupled optically to the active cavity or otherwise, e.g. electrically, by generating measurement data being related to the resistance of the active cavity. Optically coupled means that the detector is arranged in a way that the variations of the optical power density in the active cavity are either directly measured at the active cavity or indirectly by measuring the power density of the first light.

The spectral width of the first light is chosen to be such that the absorption caused by the absorption band of the gas to be detected is sufficient to detect the gas to be detected or measure the concentration of the gas to be detected. Preferably, the spectral width may be equal or even smaller than the line width of the absorption band of the gas to be detected. The driving circuit may be a simple electronic circuit driving the laser sensor unit with a constant driving current. Alternatively, the driving circuit may be a more sophisticated electronic circuit, making it possible to drive the laser sensor unit at one or more defined DC driving currents, optionally with an additional AC current component. The analyzer circuit may be a simple transistor, an ASIC or any other electronic circuit being capable of determining the presence or concentration of a gas to be detected based on the measurement signal generated by the detector. The gas detection device may comprise several laser sensor units working at different wavelengths in order to detect different gases to be detected or one gas to be detected at different absorption bands. Alternatively, the gas detection device may comprise only one laser sensor unit, and the laser sensor unit may be subsequently tuned to different wavelengths corresponding to different absorption bands of one or more gases to be detected. The gas to be detected may comprise gas molecules but also small particles such as soot particles being present e.g. in off-gases. Further, a temperature sensor and/or heating or cooling means may be added to the detection chamber in order to keep the physical conditions of the gas essentially constant. Constant physical conditions such as temperature, pressure or the like may increase the accuracy of the gas detection device.

In another embodiment in accordance with the current invention, the driving circuit is further adapted to periodically tune the wavelength of the first light, wherein the tuning range of the wavelength of the first light comprising at least the bandwidth of the absorption band of the gas to be detected. The wavelength of the first light may be tuned by means of an AC current component being supplied to the electrodes of the laser sensor device. The AC current component may be sinusoidal, triangular, saw-toothed or of any other shape being suited to periodically tune the wavelength of the laser sensor unit. A periodic variation of the wavelength of the laser sensor unit may enable scanning of the absorption band of the gas to be detected. The scanning of the absorption band may start at a first wavelength outside of the absorption band of the gas to be detected in order to calibrate the gas detection device, followed by scanning across the absorption band of the gas to be detected up to a second wavelength being also outside the absorption band of the gas to be detected. Especially if the optical feedback provided by the feedback structure is not too strong, the variation of the optical power density in the active cavity is linear as long as the absorption by the gas to be detected is not too strong and the concentration of the gas to be detected may be determined. The accuracy of the determination of the concentration of the gas to be detected may be improved if the spectral width of the first light is much smaller than the line width of the absorption band of the gas to be detected. The spectral width of the first light may be ½ or more preferably 1/10 or even more preferably 1/100 of the line width of the absorption band of the gas to be detected.

In another embodiment in accordance with the current invention, the optical feedback device is a third reflective structure and the active cavity and the third reflective structure constitute a Vertical Extended Cavity Surface Emitting Laser (VECSEL), and the detection volume is at least part of the extended cavity. In a VECSEL the first reflective structure may have a high reflectivity of more than 99.5% and the second reflective structure may have a lower reflectivity of e.g. 70%. Due to the lower reflectivity of the second reflective structure, lasing is not enabled in the active cavity without additional optical feedback. The additional optical feedback is provided by the third reflective structure being a highly reflecting mirror constituting an external or extended cavity with the second reflective structure. Due to the additional optical feedback provided by the highly reflecting mirror, lasing is enabled. Lasing may be interrupted as soon as the concentration of the gas to be detected in the detection chamber is above a certain threshold concentration. The interruption is detected by the detector, being e.g. a photodiode generating a strongly reduced photocurrent as soon as the interruption of lasing occurs and thereby the optical power density in the active cavity is strongly reduced. In this case it is not necessary that the photodiode is directly coupled to the active cavity, since the variation of the optical power density in the active cavity is very large. The photodiode may be electrically connected to the base of a transistor, being the analyzer circuit, and the transistor may switch from a first to a second state as soon as the photocurrent falls below a photocurrent threshold value. This embodiment may e.g. be used in smoke alarms.

In still another embodiment in accordance with the current invention, the active cavity constitutes a Vertical Cavity Surface Emitting Laser (VCSEL) and the optical feedback device is a diffusively scattering surface. In a VCSEL the first reflective structure may have a high reflectivity of more than 99.5% and the second reflective structure may have a lower reflectivity of e.g. 99%. The optical feedback provided by the second reflective structure is sufficient to enable lasing of the active cavity without additional optical feedback. The first light, being laser light emitted by the active cavity, passes the detection volume and may be partially absorbed by the gas to be detected. The intensity of the second light re-entering the active cavity or, in other words, the optical feedback provided by the diffusively scattering surface to the active cavity depends on the absorption of the first light by the gas to be detected. The variation of the optical power density in the active cavity caused by the optical feedback provided by the diffusively scattering surface is called self-mixing-interference. The absorption of the gas to be detected causes a further variation of the optical power density in the active cavity being detected by the detector, being e.g. a photodiode coupled to the first reflective structure. The photodiode generates measurement data based on the small portion of laser light leaking out of the active cavity. As long as the optical feedback provided by the diffusively reflective structure is not too strong, the concentration of the gas to be detected is not too high (full absorption of the first light) and the line width of the first light is sufficiently small, the measurement data generated by the photodiode depends essentially linearly on the concentration of the gas to be detected and the analyzer circuit may easily determine the concentration of the gas to be detected. Nevertheless, the optical feedback provided to the active cavity by the optical feedback structure may also be so strong that the measurement data generated by the photodiode depends non-linearly on the concentration of the gas. In this case a more sophisticated analyzer circuit e.g. comprising a storage device with reference data may be needed in order to determine the concentration of the gas to be detected. The accuracy of the gas detection device may be improved by scanning the absorption line of the gas to be detected as described above and regularly calibrating the gas detection device by regularly emitting first light with a wavelength different from the absorption band of the gas to be detected. The optical feedback provided by the optical feedback structure may be further adapted by means of an optical device being arranged between the second reflective structure and the optical feedback structure and being arranged to focus the first light on the diffusively scattering surface. The optical device may be a lens or the like.

The gas detection device in accordance with the current invention may comprise two laser sensor units, a first and a second laser sensor unit, the first laser sensor unit comprising a first Vertical Cavity Surface Emitting Laser (VCSEL), the tuning range of the wavelength of the first light emitted by the first Vertical Cavity Surface Emitting Laser comprising at least the bandwidth of the absorption band of a first gas to be detected, and the second laser sensor unit comprising a second Vertical Cavity Surface Emitting Laser (VCSEL), with the tuning range of the wavelength of the first light emitted by the second Vertical Cavity Surface Emitting Laser comprising at least the bandwidth of the absorption band of a second gas to be detected. Using two, three, four or an array of laser sensor units may enable the detection of different gases to be detected. If the concentration of different gases such as CO or CO₂ is determined, it is for example possible to determine the oxygen potential in a gas flow. Two, three, four or more laser sensor units may be tuned to different absorption bands of one gas to be detected. The measurement data generated by the detectors being coupled to the active cavities of the different laser sensor units may be used to determine independently the concentration of the gas to be detected and the analyzer circuit may be further adapted to compare the concentration of the gas to be detected. The concentration of the gas to be detected may be determined by means of a comparison of the measurement data provided by the different laser sensor units in order to improve the reliability of the gas detection device.

In another embodiment in accordance with the current invention, a control system may comprise the gas detection device, and the control system may further comprise control means, which control means are activated depending on the concentration of the gas to be detected. The control means may be in the form of ventilation that is activated as soon as the concentration of e.g. CO in a room exceeds a pre-defined threshold value. Alternatively, the control means may be in the form of an alarm that is activated as soon as e.g. smoke is detected or the concentration of smoke exceeds a certain threshold value. Alternatively, the control system may be used to control a combustion engine. The combustion engine may comprise such a control system or the combustion engine may be coupled to such a control system, wherein the gas detection device may be adapted to determine the concentration of at least one off-gas and/or soot particles of the combustion engine and the control means may be a motor controller controlling an operating point of the combustion engine in dependence on the concentration of the off-gas. The operating point of the combustion engine may be controlled by regulating the amount of fuel provided to the combustion engine in a determined period of time. Alternatively or in addition, the amount of oxidant, like e.g. oxygen, may be regulated. Further, the pressure or temperature of the combustion engine may be regulated. The gas detection device may determine the relation between different off-gases such as e.g. CO and CO₂ or different nitric oxides and the motor controller may regulate the operating point of the combustion engine in dependence on the relation between the different gases. Alternatively or in addition, the gas detection device may determine the soot concentration in the off-gas. The control system may alternatively or in addition also be arranged in the feed pipe of the combustion engine. The analyzer circuit may be a part of the motor controller or an independent circuit. A vehicle like a car, a truck, a train or the like may comprise the combustion engine and the control system.

It is a further object of the present invention to provide an improved method of detecting gas.

The object is achieved by means of a method of detecting gas comprising the steps of:
generating first light in an active cavity of a laser, at least a part of the first light being adapted to be absorbed by an absorption band of a gas to be detected,
emitting the first light across a detection volume being adapted to contain the gas to be detected,
providing optical feedback to the active cavity by means of second light being scattered or reflected first light re-entering the active cavity,
varying a laser power in the active cavity by means of the absorption of the first light by the gas to be detected,
coupling a detector to the active cavity,
generating measurement data by means of the detector being related to the varying laser power in the active cavity,
supplying the measurement data to an analyzer circuit,
determining the presence and/or the concentration of the gas to be detected by means of the analyzer circuit, based on the measurement data received from the detector.

In another embodiment in accordance with the current invention, the method comprises the additional steps of:
activating a motor controller by means of the analyzer circuit in dependence on the concentration of an off-gas and/or soot particles of a combustion engine and
controlling an operating point of the combustion engine in dependence on the concentration of the off-gas and/or soot particles by means of the motor controller.

In a further aspect of the current invention, a computer program for controlling a combustion engine of for example a car is presented. The computer program comprises program code means for causing the control system as defined in claim 8 to carry out the steps of the method as defined in claim 10, when the computer program is run on a computer controlling the control system of the combustion engine.

It will be understood that the gas detection device of claim 1, the method of claim 10, the combustion engine of claim 8 and the computer program of claim 13 have similar and/or identical embodiments as defined in the dependent claims.

It will be understood that a preferred embodiment of the invention can also be any combination of the dependent claims with a respective independent claim.

### BRIEF DESCRIPTION OF THE DRAWINGS

These and other aspects of the invention will be apparent from and elucidated with reference to the embodiments described hereinafter. In the following drawings:

FIG. 1 shows schematically a laser sensor unit being comprised in a first embodiment of the gas detection device in accordance with the current invention.

FIG. 2 shows schematically a further laser sensor unit being comprised in a second embodiment of the gas detection device in accordance with the current invention.

FIG. 3 shows schematically an embodiment of the gas detection device in accordance with the current invention.

FIG. 4 shows measurement data that may be generated by the detector due to the presence of gas to be detected in the detection chamber.

FIG. 5 shows a control system in accordance with another embodiment of the current invention.

FIG. 6 shows a vehicle with a combustion engine in accordance with the current invention.

### DETAILED DESCRIPTION OF EMBODIMENTS

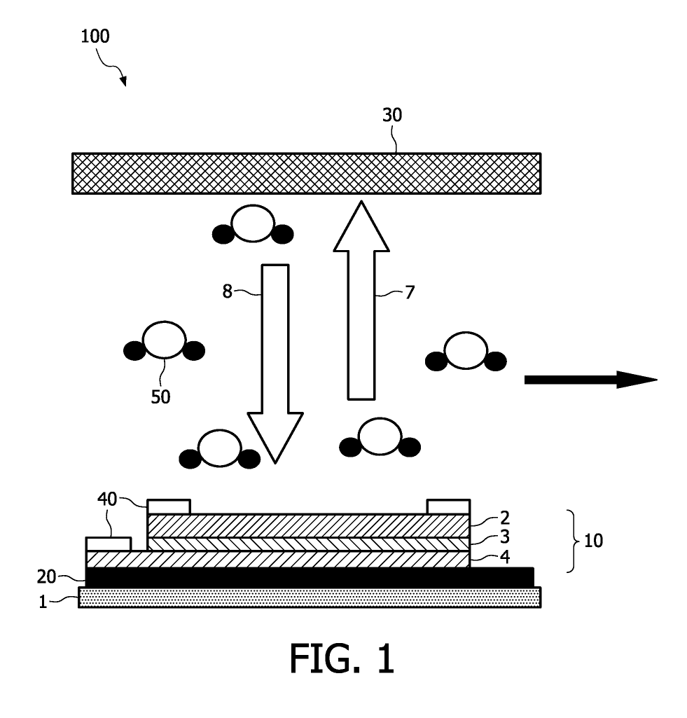

FIG. 1 shows schematically a laser sensor unit 100 comprising a Vertical Cavity Surface Emitting Laser (VCSEL) with an active cavity 10 comprising a first reflective structure 4, e.g. a Distributed Bragg Reflector (DBR) with a reflectivity of more than e.g. 99.5%, a second reflective structure 2 being a DBR with a reflectivity of around 99%, and an active layer 3 like a quantum well layer embedded between both DBRs. The detector 20 is a photodiode being attached to the first reflective structure 4 and to a substrate 1 being a semiconductor substrate or any other substrate that may be used for this purpose. Electrodes 40 are attached to the DBRs in order to inject current in the active layer via the electrically conductive DBRs. The current is used to electrically pump the active layer in order to emit first light 7, being laser light, through the second reflective structure 2. Between the second reflective structure 2 and a diffusively scattering surface being an optical feedback structure 30, there is a detection volume with a gas to be detected 50 flowing through the detection volume. The first light 7 and the scattered first light 8 is partially absorbed by the gas to be detected and re-enters the active cavity 10 as second light influencing the optical power density in the active cavity 10 by means of self-mixing-interference. A part of the light in the active cavity leaks through the highly reflective first reflective structure 4 and is detected by means of the photodiode. Consequently, the measurement data generated by the photodiode is influenced by the absorption of the first light 7, 8 by the gas to be detected, and the measurement data can be used to determine the presence and/or concentration of the gas to be detected 50.

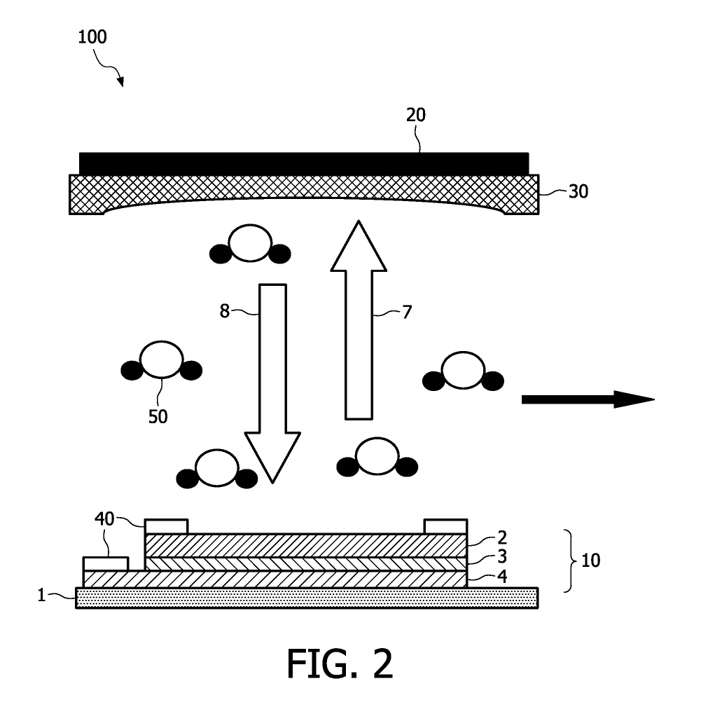

FIG. 2 shows schematically a further laser sensor unit 100 that may be part of a gas detection device in accordance with the current invention. The laser sensor unit 100 comprises a Vertical Extended (or External) Cavity Surface Emitting Laser (VECSEL). The VECSEL comprises a first reflective structure 4, e.g. a Distributed Bragg Reflector (DBR) with a reflectivity of more than e.g. 99.5%, a second reflective structure 2 being a DBR with a reflectivity of around 70% and an active layer 3 like a quantum well layer embedded between both DBRs. The optical feedback from the second reflective structure 2 is not sufficient to enable lasing of the active cavity 10 as in the case of a VCSEL. The VECSEL further comprises an optical feedback structure being e.g. a further DBR with a high reflectivity of e.g. 99%. The cavity between the second reflective structure 2 and the optical feedback structure 30 is the extended or external cavity of the VECSEL, being at least a part of the detection volume. The optical feedback structure 30 is adapted to provide sufficient optical feedback to the active cavity in order to enable lasing of the VECSEL. As discussed in FIG. 1 above, electrodes 40 are attached to the DBRs in order to inject current in the active layer via the electrically conductive DBRs constituting the first and second reflective structure 2, 4. The first reflective structure 4 is directly attached to a substrate 1 and a photodiode being the detector 20 is attached to a side of the optical feedback structure 30 such that the photodiode is outside of the extended cavity. As discussed in connection with FIG. 1, a gas to be detected 50 passing the detection volume causes the absorption of at least a part of the first light 7, 8. As soon as the absorption exceeds a defined threshold value, lasing of the VECSEL is no longer possible since the optical feedback provided by the optical feedback structure is no longer sufficient to enable lasing. The interruption of lasing and the related variation of the optical power density in the active cavity 10 is detected by the photodiode and corresponding measurement data is generated.

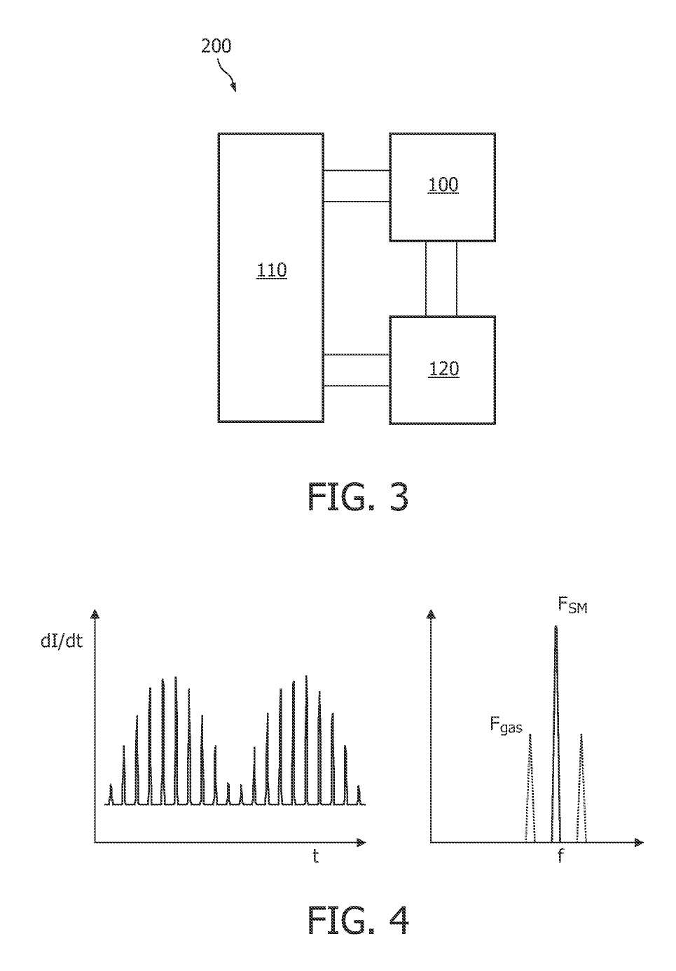

In FIG. 3 an embodiment of a gas detection device 200 in accordance with the current invention is schematically depicted. A laser sensor unit 100 as shown in FIG. 1 or 2 is connected to a driving circuit 110. The driving circuit 110 drives the laser sensor unit at a defined DC current with an additional AC current component in order to tune the wavelength of the laser sensor unit 100 for scanning an absorption band of a gas to be detected. The measurement data generated by the detector of the laser sensor unit 100 is received via wire or wireless by the analyzer circuit 120. The analyzer circuit 120 determines the presence and/or the concentration of the gas to be detected based on the measurement data provided by means of the laser sensor unit 100. Further, the analyzer circuit 120 in this embodiment is adapted to provide feedback to the driving circuit 110 in order to adapt the DC current and/or AC current component supplied to the laser sensor unit 100 to e.g. the wavelength and line width of the absorption band of a gas to be detected. This measure may be needed if the laser sensor unit 100 is adapted to generate measurement data with respect to different gases to be detected having different absorption bands.

Typical measurement data, for example, the time derivative of photocurrent signals detected by the photodiode of the laser sensor unit 100 as shown in FIG. 1 is shown on the left side of FIG. 4. The DC component of the measurement data corresponds to VCSEL output power without optical feedback. The high frequency component F_{SM} of the measurement data corresponds to self-mixing between the laser light generated in the active cavity 10 and backscattered second light re-entering the active cavity 10. The tuning of the emission wavelength of the VCSEL through injection current modulation is periodically performed by means of an AC component (for example a sawtooth AC current) supplied by the driving circuit 110 via the electrodes 40. The amplitude of the self-mixing signals is undulated due to gas absorptions caused by an absorption band of the gas to be detected 50 in the detection volume. The line width of the absorption band is within the tuning range of the emission wavelength of the VCSEL and the line width of the laser emission is small in comparison to the line width of the absorption band of the gas to be detected. The right side of FIG. 4 shows the analysis of the measurement data in the frequency domain after a Fourier transform of the measurement data generated by the laser sensor unit 100. The Fourier transform or Fast Fourier Transform is performed by means of the analyzer circuit 120. The amplitude of the signals is shown in dependence on the frequency of the signal. Gas to be detected 50 in the optical path contributes to side bands of F_{SM}. The amplitude of the side bands F_{gas} indicates the concentration of corresponding gas to be detected 50 and is thereby determined by means of the analyzer circuit 120

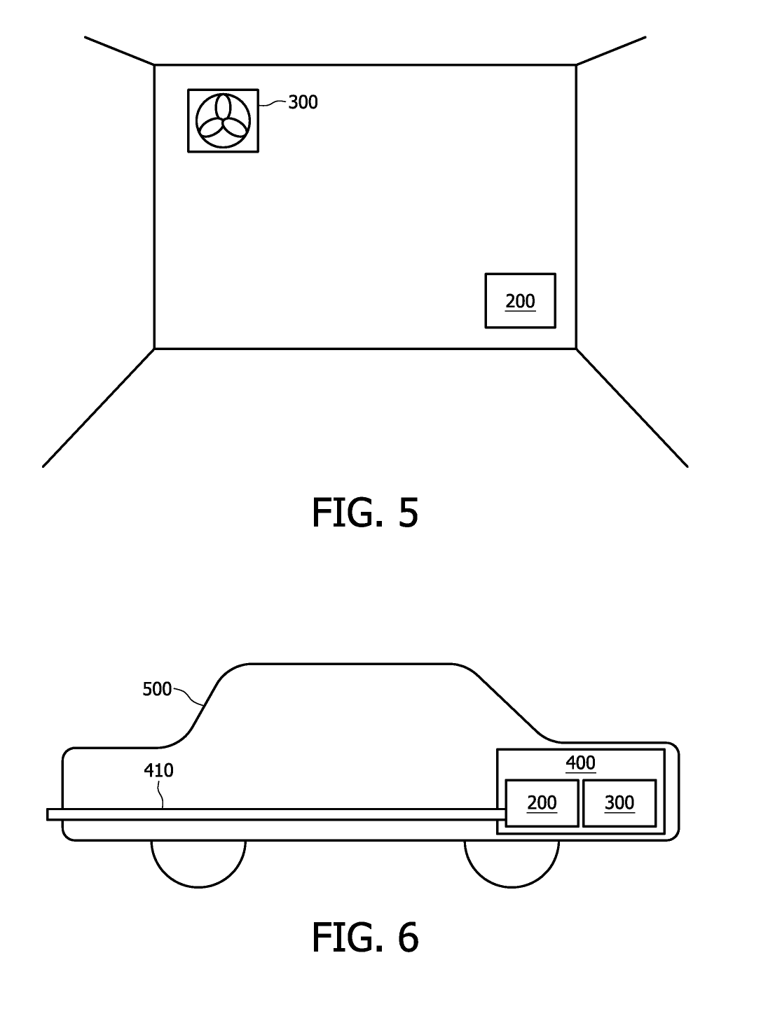

In FIG. 5 a control system is shown comprising a gas detection device 200 with a laser sensor unit 100 as described in connection with FIG. 2 and a control means 300, being ventilation, coupled via wire or wirelessly to the gas detection device 200. The control system may e.g. be installed in a room with a heating device producing CO as off-gas. The gas detection device activates the ventilation as soon as the concentration of CO exceeds a predefined threshold value.

In FIG. 6 a combustion engine 400 is shown being integrated in a vehicle like a car. The combustion engine 400 comprises a gas detection device 200 with several laser sensor units 100 as depicted in FIG. 1. The combustion engine 400 further comprises a control means 300 being a motor controller. The gas detection device 200 determines e.g. the concentration of CO, CO₂, NO and NO₂ in the off-gas of the combustion engine 400 leaving the vehicle via the exhaust pipe 410. The gas detection device activates the motor controller if e.g. the concentration of one of the gases or the relation of two of the gases exceeds pre-defined threshold values. The motor controller changes the operating point of the combustion engine by changing e.g. the amount of fuel and/or oxygen supplied to the combustion engine.

According to an idea of the current invention, self-mixing interference is used to determine the presence and/or concentration of gases. The coupling of the detector to the active cavity simplifies the gas detection device in comparison to the prior art. VCSEL or VECSEL may be suited for this purpose since those lasers are commercially available in a wavelength range between 0.7 μm and 2 μm and industrial and environmental gases have absorption bands in this wavelength range, as depicted in Table 1.

TABLE 1
Absorption peaks of gas molecules in the near-infrared range

| Gas Molecules | | Absorption Peak (nm) |
|---|---|---|
| Water | H2O | 1390/1802 |
| Carbon Dioxide | CO2 | 1960 |
| Carbon | CO | 1570/2330 |
| Monoxide | | |
| Nitric Oxide | NO | 1800/2650 |
| Nitrogen Dioxide | NO2 | 680 |
| Nitrous Oxide | N2O | 2260 |
| Oxygen | O2 | 763 |
| Methane | CH4 | 1650 |
| Acetylene | C2H2 | 1520 |

Further, VCSEL and VECSEL can be manufactured by semiconductor processing, which may enable cost savings.

Although in the above described embodiment the sensors are VCSEL-based self-mixing interference sensors, in other embodiments other sensors can be used which are based on self-mixing interference sensors. Any coherent light source, like a solid-state laser, gas laser, monochromatic light source for distance vision (sodium lamps) et cetera, can be used in combination with an interferometric system.

In the claims, the word “comprising” does not exclude other elements or steps, and the indefinite article “a” or “an” does not exclude a plurality.

The mere fact that measures are recited in mutually different dependent claims does not indicate that a combination of these measures cannot be used to advantage.

A single unit or device may fulfill the functions of several items recited in the claims. The mere fact that certain measures are recited in mutually different dependent claims does not indicate that a combination of these measures cannot be used to advantage.

Determinations, calculations et cetera by one or several units or devices can be performed by any other number of units or devices. The control of the gas detection device, the control system and the combustion engine in accordance with the method can be implemented as program code means of a computer program and/or as dedicated hardware.

A computer program may be stored/distributed on a suitable medium, such as an optical storage medium or a solid-state medium, supplied together with or as part of other hardware, but may also be distributed in other forms, such as via the Internet or other wired or wireless telecommunication systems.

The reference signs in the claims should not be construed as limiting the scope of these claims.

### LIST OF REFERENCE SIGNS

1 substrate
2 second reflective structure
3 active layer
4 first reflective structure
7 first light
8 first light being scattered or reflected by the optical feedback structure
10 active cavity
20 detector
30 optical feedback structure
40 electrodes
50 gas to be detected
100 laser sensor unit
110 driving circuit
120 analyzer circuit
200 gas detection device
300 control means
400 combustion engine
410 exhaust pipe

1. A gas detection device (200) comprising at least one laser sensor unit (100), a driving circuit (110) and an analyzer circuit (120),
the laser sensor unit comprising at least one active cavity (10), electrodes (40), at least one optical feedback structure (30), a detection volume and at least one detector (20), the active cavity (10) comprising an active layer (3) sandwiched between a first reflective structure (4) and a second reflective structure (2), the first reflective structure (4) having a higher reflectivity than the second reflective structure (2), the electrodes (40) being adapted to inject electrical current in the active layer (3), the detector (20) being coupled to the active cavity (10), the detection volume being arranged between the second reflective structure (2) and the optical feedback structure (30) and the detection volume being adapted to contain a gas to be detected (50),
the driving circuit (110) being electrically coupled to the electrodes (40) and the driving circuit (110) being adapted to electrically pump the active cavity (10) such that first light is emitted via the second reflective structure (2) in the detection volume and at least a part of the first light being adapted to be absorbed by an absorption band of the gas to be detected (50),
the optical feedback structure (30) being arranged to scatter or reflect the first light (7) through the detection volume, causing it to re-enter the active cavity (10),
the scattered or reflected first light (8) re-entering the active cavity (10) being second light causing a variation of a laser power in the active cavity (10) in dependence on the absorption of the first light (7, 8) by the gas to be detected (50) in the detection volume,
the detector (20) being adapted to generate measurement data being related to the laser power in the active cavity (10),
the detector (20) being coupled to the analyzer circuit (120) and the analyzer circuit (120) being adapted to determine the presence and/or the concentration of the gas to be detected (50), based on the measurement data received from the detector (20).

2. The gas detection device (200) in accordance with claim 1, wherein the first light (7, 8) is characterized by a spectral width being smaller than the line width of an absorption band of a gas to be detected (50).

3. The gas detection device (200) in accordance with claim 1, wherein the driving circuit is further adapted to periodically tune the wavelength of the first light (7, 8), wherein the tuning range of the wavelength of the first light (7, 8) comprises at least the bandwidth of the absorption band of the gas to be detected (50).

4. The gas detection device (200) in accordance with claim 1, wherein the optical feedback device is a third reflective structure and the active cavity, the third reflective structure comprises a Vertical Extended Cavity Surface Emitting Laser (VECSEL) and the detection volume is at least part of the extended cavity.

5. The gas detection device (200) in accordance with claim 3, wherein the active cavity comprises a Vertical Cavity Surface Emitting Laser (VCSEL) and the optical feedback device is a diffusively scattering surface.

6. The gas detection device (200) in accordance with claim 5, further comprising an optical device being arranged between the second reflective structure (2) and the diffusively scattering surface, and the optical device being arranged to focus the first light on the diffusively scattering surface.

7. The gas detection device (200) in accordance with claim 5, comprising at least two laser sensor units (100), a first and a second laser sensor unit (100), the first laser sensor unit (100) comprising a first Vertical Cavity Surface Emitting Laser (VCSEL), wherein the tuning range of the wavelength of the first light (7, 8) emitted by the first Vertical Cavity Surface Emitting Laser comprises at least the bandwidth of the absorption band of a first gas to be detected (50), and the second laser sensor unit (100) comprising a second Vertical Cavity Surface Emitting Laser (VCSEL), wherein the tuning range of the wavelength of the first light (7, 8) emitted by the second Vertical Cavity Surface Emitting Laser comprises at least the bandwidth of the absorption band of a second gas to be detected (50).

8. A control system comprising a gas detection device (200) in accordance with claim 1, the control system further comprising control means (300) and the control means being activated depending on the concentration of the gas to be detected.

9. (canceled)

10. A method of detecting gas, comprising the steps of:
generating first light (7, 8) in an active cavity (10) of a laser, at least a part of the first light (7, 8) being adapted to be absorbed by an absorption band of a gas to be detected (50),
emitting the first light (7) across a detection volume being adapted to contain the gas to be detected,
providing optical feedback to the active cavity (10) by means of second light being scattered or reflected first light (8) re-entering the active cavity (10),
varying a laser power in the active cavity (10) by means of the absorption of the first light by the gas to be detected (50),
coupling a detector (20) to the active cavity (10),
generating measurement data, by means of the detector (20), being related to the varying laser power in the active cavity (10),
supplying the measurement data to an analyzer circuit (120),
determining the presence and/or the concentration of the gas to be detected (50) by means of the analyzer circuit (120), based on the measurement data received from the detector (20).

11. A method in accordance with claim 10, the method comprising the additional steps of:
activating a motor controller by means of the analyzer circuit (120) in dependence on the concentration of an off-gas and/or soot particles of a combustion engine (400) and
controlling an operating point of the combustion engine (400) in dependence on the concentration of the off-gas and/or soot particles by means of the motor controller.

12. (canceled)
